(19) United States
(12) Patent Application Publication
(10) Pub. No.: US 2017/0062148 A1
(43) Pub. Date: Mar. 2, 2017

(54) CONTROL FOR SNOW PLOW OR WINCH

(71) Applicant: Thomas Joseph Legel, Birdsboro, PA (US)

(72) Inventor: Thomas Joseph Legel, Birdsboro, PA (US)

(21) Appl. No.: 15/248,969

(22) Filed: Aug. 26, 2016

Related U.S. Application Data
(60) Provisional application No. 62/210,201, filed on Aug. 26, 2015.

(51) Int. Cl. H01H 13/02; B60R 16/02; H01H 25/04; E01H 5/06

(52) U.S. Cl. CPC H01H 13/023; E01H 5/061; B60R 16/0207; H01H 25/04; H01H 2219/036

(57) ABSTRACT

A transmission shift lever mounted controller for a snow plow or winch for a motor vehicle. The controller may be made of a flexible housing that slips over the top of the transmission shift lever as a cover. The controller carries switches to control the plow or winch on the transmission shift lever. This allows the operator to control both the snow plow or winch and the transmission shift lever at without having to move his/her hand back and forth between the two. The controller also allows control of the snow plow or winch and the transmission shift lever simultaneously.

### CROSS-REFERENCE TO RELATED APPLICATION

This application claims the benefit of priority of U.S. provisional application No. 62/210,201, filed Aug. 26, 2015, the contents of which are herein incorporated by reference.

### BACKGROUND OF THE INVENTION

The present invention relates to motor vehicle mounted snow plows and winches and, more particularly to controllers for motor vehicle mounted snow plows and winches.

Current snow plow or winch controllers are hand held or mounted on the dashboard of a motor vehicle. This requires the motor vehicle operator to use a single hand to control both the snow plow or winch as well as the transmission shift lever (automatic or manual transmission) while steering the vehicle with the other hand. This practice is unsafe and cumbersome.

The main problem is while operating a vehicle with a snow plow or winch, the operator only has two hands, but three devices to operate: 1) the steering wheel, 2) the transmission shift lever and 3) the snow plow or winch. This means the operator is continuously switching one hand between the transmission shift lever and the snow plow or winch controller.

As can be seen, there is a need for a snow plow or winch controller that permits the operator to control both the snow plow or winch and the transmission shift lever without having to move his/her hand back and forth between the two operating controls.

The controller is made of a flexible housing, and slips over a top end of the transmission shift lever as a cover, and houses the switches on the transmission shift lever. This allows, and also allows control of the snow plow or winch and the transmission shift lever simultaneously.

### SUMMARY OF THE INVENTION

In one aspect of the present invention, a controller for a motor vehicle mounted work accessory, includes: a housing carrying at least one control operable to control the vehicle mounted work accessory, wherein the housing is configured to attach to a transmission shift lever for the motor vehicle; and a wiring harness configured to interconnect the at least one control switch with a power distribution system to power the vehicle mounted work accessory. The housing may be formed of a resilient material adapted to resiliently receive the transmission shift lever. One or more indicator lights may also be carried in the housing to provide a visual indication of an operational condition of the work accessory.

In other aspects of the invention, the at least one control comprises a plurality of control switches positioned on an upper surface of the housing. The plurality of control switches are configured to be operable by a fingertip of a user's hand, while operating the transmission shift lever. The housing may also be configured to be received on a laterally disposed transmission shift lever. Alternatively, the hosing is configured to be received on a vertically disposed transmission shift lever. In some embodiments, the plurality of control switches provide a tactile indicia of a corresponding operational movement of the vehicle mounted work accessory. The plurality of controls may also provide a visual indicia of the corresponding operational movement. The vehicle mounted work accessory comprises at least one of a snow plow or a winch. In yet other aspects of the invention, the at least one control comprises a joystick operably attached at an end of the housing.

In further aspects of the invention, a control system for a motor vehicle mounted work accessory includes: a controller having a housing carrying a plurality of control switches to control the operation of the vehicle mounted work accessory, wherein the housing is configured to attach to a transmission shift lever for the motor vehicle; a power distribution system with a relay panel configured to be interposed between the controller and a drive system for the work accessory; and a wiring harness configured to interconnect the plurality of control switches with the power distribution system. The plurality of control switches are preferably positioned on an upper surface of the housing and may be configured to be operable by a fingertip of a user's hand while operating the transmission shift lever. The housing may be configured to be received on a laterally or a vertically disposed transmission shift lever. The plurality of control switches may provide a tactile indicia of a corresponding operational movement of the vehicle mounted work accessory. In other embodiments, the plurality of controls provide a visual indicia of the corresponding operational movement. The vehicle mounted work accessory comprises at least one of a snow plow or a winch.

In yet other aspects of the invention for a motor vehicle mounted work accessory, includes a housing carrying at least one control operable to control the vehicle mounted work accessory, wherein the housing is configured to attach to a transmission shift lever for the motor vehicle, and the at least one control is configured to be operable by a fingertip of an operator while manipulating the transmission shift lever.

These and other features, aspects and advantages of the present invention will become better understood with reference to the following drawings, description and claims.

### BRIEF DESCRIPTION OF THE DRAWINGS

FIG. 1 is a perspective detail view of an embodiment of the controller shown in use mounted to a shift lever of a motor vehicle.

FIG. 2 is a perspective detail/schematic view of a controller mounted to a transmission shift lever of a motor vehicle.

FIG. 3 is a perspective view of a controller according to aspects of the invention.

FIG. 4 is an exploded view of a controller aligned for attachment to a transmission shift lever.

FIG. 5 is a section detail view of the controller taken along line 5-5 of FIG. 2.

FIG. 6 is a perspective/schematic view of an alternative embodiment of a controller according to aspects of the invention.

FIG. 7 is an exploded view of an alternative embodiment of the controller aligned for mounting on a transmission shift lever.

FIG. 8 is a perspective view of an alternative view of an alternative embodiment of the controller shown in use mounted to a motor vehicle transmission shift lever.

FIG. 9 is a sectional view of the alternative embodiment of the controller taken along line 9-9 of FIG. 8.

FIG. 10 is a perspective view of a relay box.

FIG. 11 is a perspective view of an alternative embodiment of a controller.

FIG. 12 is a side view of the alternative view of the controller shown in FIG. 11.

FIG. 13 is an electrical schematic view of the controller according to aspects of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a controller for a snow plow or winch that permits a motor vehicle operator to control a vehicle mounted work accessory, such as a snow plow or a winch and the transmission shift lever for the motor vehicle without having to move his/her hand back and forth between operating controls positioned in disparate locations.

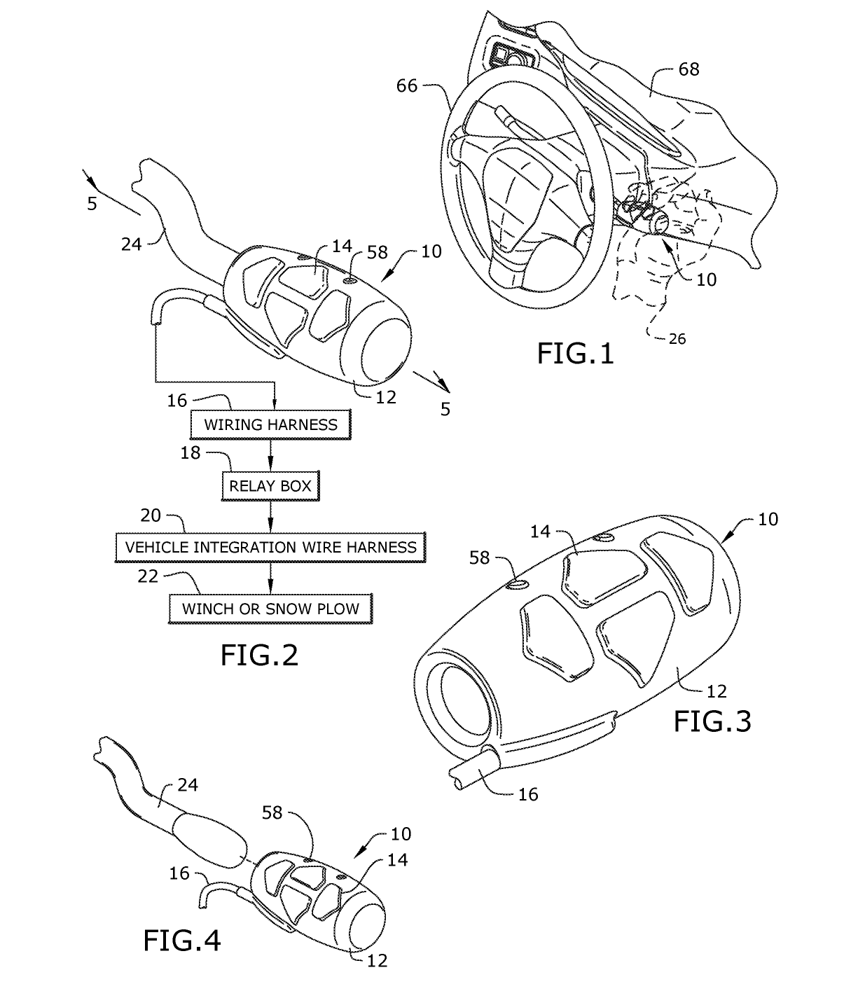

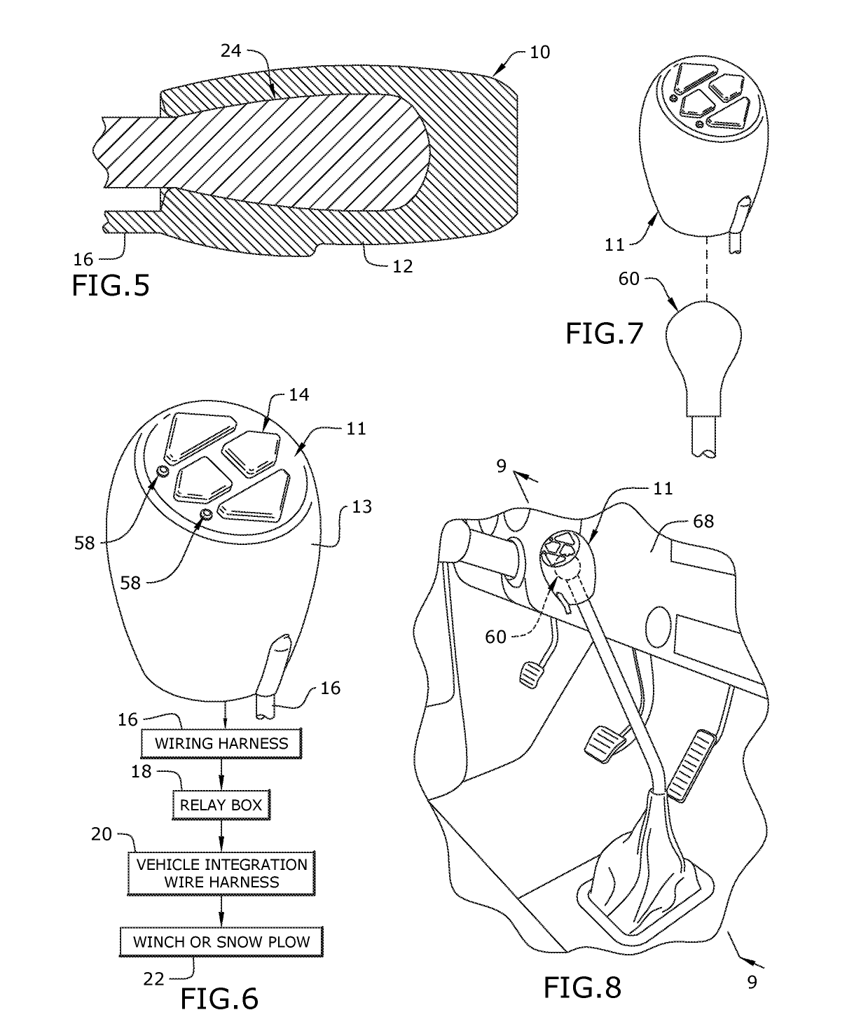

As seen in reference to FIGS. 1-5, a first embodiment of the controller 10 of the present invention includes a housing or body 12 that is configured to conveniently mount to a laterally oriented transmission shift lever 14, such as one that may be mounted to a steering column of a motor vehicle. The transmission shift lever 24 is operated by a firsthand 26 of a vehicle operator. A second hand of the vehicle operator is typically utilized to operate the steering wheel 66 for the motor vehicle.

The housing 12, carries a plurality of controls, such as buttons or switches 14, to operate the vehicle mounted work accessory 22, which may be one or more of a snow plow, a winch, or other work accessory carried by the motor vehicle. The controls 14 may be oriented on an upper surface of the housing. The controls are preferably oriented so that the operator may activate the controls 14 with their fingertips while manipulating the transmission shift lever 14. The housing may also carry one or more indicator lights 58 that illuminate to provide the operator a visual indication of the operational status or condition of the one or more vehicle mounted accessories. The controls 14 are operatively connected to the work accessory 22 via a wiring harness 16, a relay box 18, and a vehicle integration wiring harness 20.

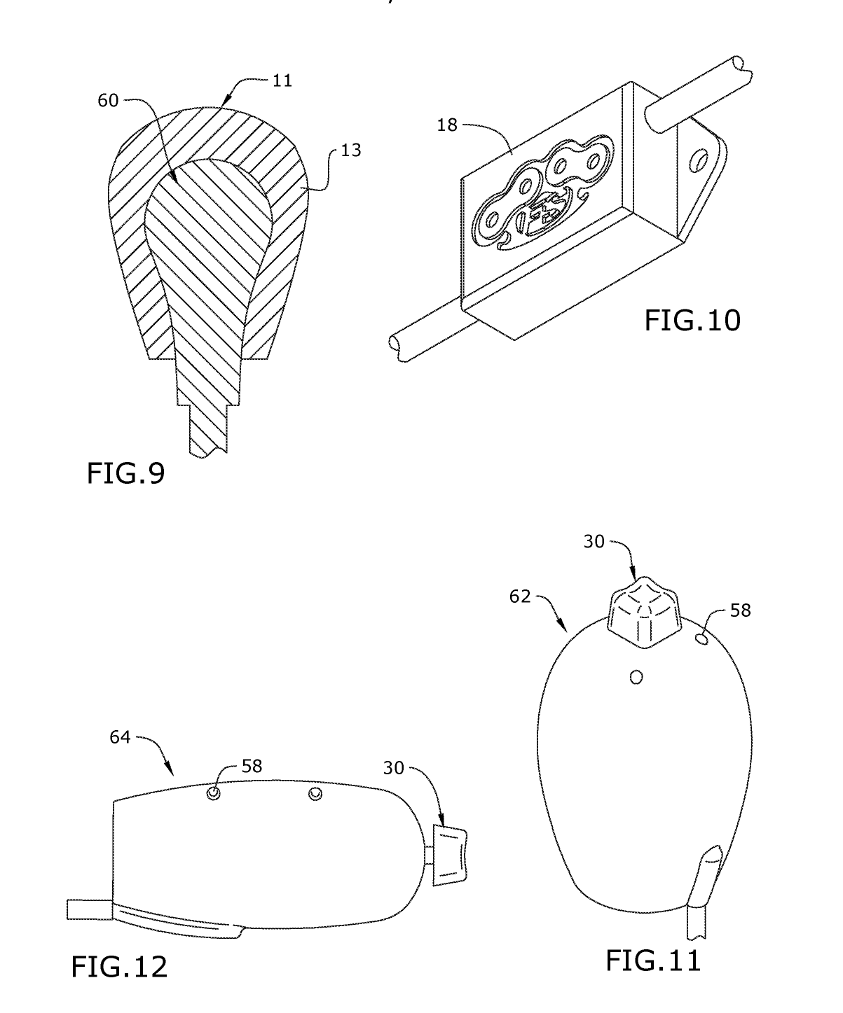

In the alternative embodiment of the controller 11 shown in reference to FIGS. 6-9, the controller 11 is configured for mounting to a vertically oriented transmission shift lever 60. The controller housing 13 carries a plurality of controls 14 for operation of the vehicle mounted work accessory. The housing 13 may also carry one or more indicator lights 58 that illuminate to provide a visual indication of the operational status of the vehicle mounted work accessory. The controls 14 or oriented on an upper surface of the housing 13 and are preferably oriented so that they may be operated by the thumb of the operator's first hand while operating the transmission shift lever 60.

In the embodiments of FIGS. 1-9, the controls 14 may provide for one or more of an elevation or rotation of a snow plow blade or an extension or retraction of a winch when the accessories are operatively coupled to the vehicle. The controls 14 may be shaped to provide a visual or tactile indicia of the operation the control is configured to perform. By way of example an up and a down arrow shaped control 14 may be configured for an elevation control of the snow plow blade, while a left and a right arrow shaped control 14 may be configured for directional articulation of the snow plow blade to the left or the right.

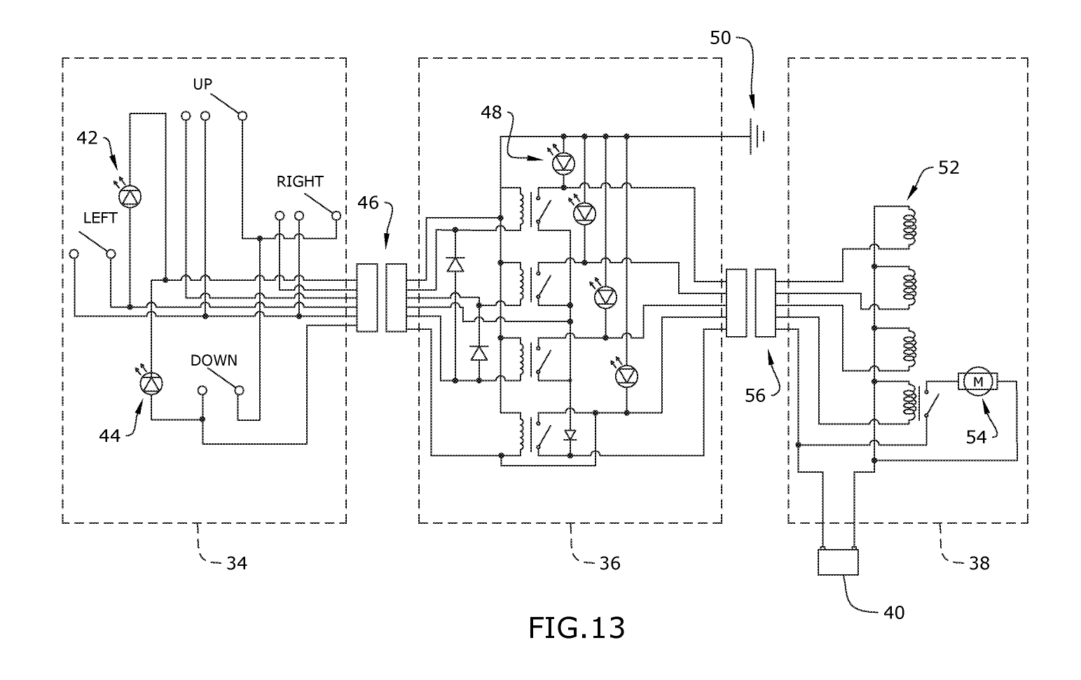

In another alternative embodiment of the controller 64, shown in reference to FIG. 12 is configured with an elongate body for attachment to a horizontally oriented shift lever 24. The controller 62 shown FIG. 13, configured with a bulbous body for a vertically oriented shift lever 60. The control 30 of these alternative embodiments, may include a joystick control 30 that is responsive to an axial displacement of the control 30 in a plurality of directions to move the work accessory in a corresponding direction. By way of example, a fore and an aft axial displacement of the control 30 may correspond to an up and a down elevational control of the snow plow blade, while a left and a right axial displacement of the control 30 may correspond to a directional articulation of the blade to the left or to the right.

In each of the embodiments, the controller 10, 11, 62, and 64 may be carried in a flexible housing or body that can resiliently slip over top of the transmission shift lever (automatic or manual transmission) and thereby conveniently mounts the controller 10, 11, 62, 64 and its associated controls on the intended shift lever. Alternatively, the body may be a rigid shell, formed by shell portions that are interconnected by one or more of a fastener, such as a screw, a snap fit tab, or an adhesive.

A representative electrical schematic diagram of the controller is illustrated in reference to FIG. 13. A snow plow shift control 34 is shown with one or more elevation control buttons, corresponding to an upward and a downward movement of the snow plow blade. A left and a right control switches may control a directional articulation of the snow plow blade to the left or to the right. In this embodiment of the electrical schematic, a first light emitting diode (LED) 42 illuminates to provide a visual indication that the system power is applied. A second LED illuminates to provide a visual indication of the float of the blade. The snow plow shift control is operatively connected to a relay board 36 via a connector 46 to operatively connect a wiring harness from the control 34 to the wiring harness of the relay board 36. The relay board 36 may be carried within a relay box 18, illustrated in FIG. 10, which is preferably mounted within a cabin of the motor vehicle, such as beneath the dashboard 68. The relay board 36 may also include one or more LEDs 48, to provide a visual indication of the operating conditions of the snow plow for diagnostics, installation, and troubleshooting of the system. The relay board 36 may also be configured with a chassis ground connection 50.

A connector 56 may interconnect the wiring harnesses from the relay board 36 with a drive system for the vehicle mounted work accessory. By way of non-limiting example the wiring harness the drive system may include a hydraulic control unit 38 of the snow plow. The hydraulics control unit 38 has a plurality of control valve solenoids 52, which control the flow of a hydraulic fluid to one or more hydraulic actuators to controls the articulation of the snow plow blade. The hydraulic actuators are operable via a source of pressurized hydraulic fluid provided by a hydraulic pump 54. Electrical power for the system is provided by an electrical source, such as a battery 40.

It should be understood, of course, that the foregoing relates to exemplary embodiments of the invention and that modifications may be made without departing from the spirit and scope of the invention as set forth in the following claims.

What is claimed is:

1. A controller for a motor vehicle mounted work accessory, comprising:
a housing carrying at least one control operable to control the vehicle mounted work accessory, wherein the housing is configured to attach to a transmission shift lever for the motor vehicle;
a wiring harness configured to interconnect the plurality of control switches with a power distribution system to power the vehicle mounted work accessory.

2. The controller of claim 1, wherein the housing is formed of a resilient material adapted to resiliently receive, the transmission shift lever.

3. The controller of claim 1, further comprising:
one or more indicator lights carried in the housing to provide a visual indication of an operational condition of the work accessory.

4. The controller of claim 1, wherein the at least one control comprises a plurality of control switches positioned on an upper surface of the housing.

5. The controller of claim 4, wherein the plurality of control switches are configured to be operable by a finger tip of a user's hand, while operating the transmission shift lever.

6. The controller of claim 5, wherein the housing is configured to be received on a laterally disposed transmission shift lever.

7. The controller of claim 5, wherein the hosing is configured to be received on a vertically disposed transmission shift lever.

8. The controller of claim 5, wherein the plurality of control switches provide a tactile indicia of a corresponding operational movement of the vehicle mounted work accessory.

9. The controller of claim 8, wherein the plurality of controls provide a visual indicia of the corresponding operational movement.

10. The controller of claim 9, wherein the vehicle mounted work accessory comprises at least one of a snow plow or a winch.

11. The controller of claim 1, wherein the at least one control comprises a joystick operably attached at an end of the housing.

12. A control system for a motor vehicle mounted work accessory, comprising:
a controller comprising a housing carrying a plurality of control switches to control the operation of the vehicle mounted work accessory, wherein the housing is configured to attach to a transmission shift lever for the motor vehicle;
a power distribution system comprising a relay panel configured to be interposed between the controller and a drive system for the work accessory; and
a wiring harness configured to interconnect the plurality of control switches with the power distribution system.

13. The control system of claim 12, wherein the plurality of control switches are positioned on an upper surface of the housing.

14. The control system of claim 12, wherein the plurality of control switches are configured to be operable by a fingertip of a user's hand, while operating the transmission shift lever.

15. The control system of claim 13, wherein the housing is configured to be received on a laterally disposed transmission shift lever.

16. The control system of claim 14, wherein the hosing is configured to be received on a vertically disposed transmission shift lever.

17. The control system of claim 15, wherein the plurality of control switches provide a tactile indicia of a corresponding operational movement of the vehicle mounted work accessory.

18. The control system of claim 17, wherein the plurality of controls provide a visual indicia of the corresponding operational movement.

19. The control system of claim 14, wherein the vehicle mounted work accessory comprises at least one of a snow plow or a winch.

20. A controller for a motor vehicle mounted work accessory, comprising:
a housing carrying at least one control operable to control the vehicle mounted work accessory, wherein the housing is configured to attach to a transmission shift lever for the motor vehicle, and the at least one control is configured to be operable by a fingertip of an operator while manipulating the transmission shift lever.
